(19) United States
(12) Patent Application Publication
(10) Pub. No.: US 2013/0268130 A1
(43) Pub. Date: Oct. 10, 2013

(54) FILLING STATION WITH COMMUNICATION

(71) Applicants: Robert Adler, Gerasdorf (AT); Georg Siebert, Wien (AT); Markus Mayer, Vosendorf (AT)

(72) Inventors: Robert Adler, Gerasdorf (AT); Georg Siebert, Wien (AT); Markus Mayer, Vosendorf (AT)

(21) Appl. No.: 13/703,782

(22) PCT Filed: Jul. 7, 2011
(86) PCT No.: PCT/EP2011/003385

§ 371 Date: May 22, 2013

(30) Foreign Application Priority Data
Jul. 20, 2010 (DE) 10 2010 027 683,9

(51) Int. Cl. G05D 7/06

(52) U.S. Cl. CPC G05D 7/0676
USPC 700/283

(57) ABSTRACT

The invention relates to a filling station for a pressurized gas such as hydrogen or natural gas for refuelling a vehicle tank, wherein
a storage tank (VT),
a computer on the filling station side (PLC), which can open and close a discharge valve,
a tank pipe between storage tank (VT) and vehicle tank to be filled and
a communication connection (KV) to the vehicle are provided.

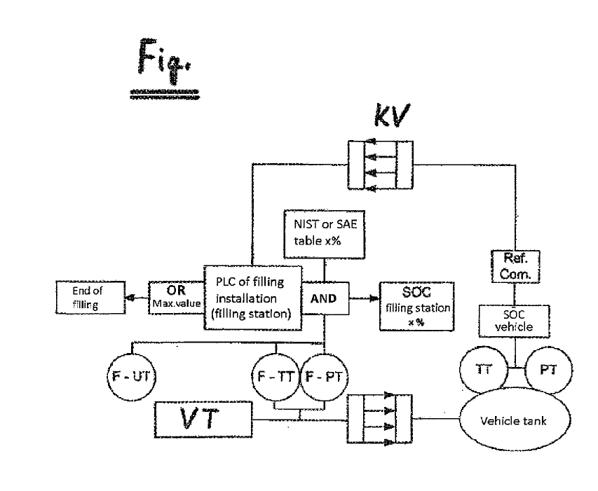

In order to increase safety
a vehicle-side computer for calculating the vehicle-side degree of filling (Status of Charge, SOC vehicle), and
a pressure measuring device on the filling station side (F-PT) in the tank pipe are provided
   wherein the computer on the filling station side (PLC) calculates the initial SOC filling station from a measured value of the pressure measuring device on the filling station side (F-PT) and at least one temperature value and controls the refuelling with the information of the pressure measuring device on the filling station side (F-PT) until the target pressure or target SOC filling station or until an abort signal which comes from the vehicle-side computer (Figure).

The invention relates to a filling station according to the preamble of claim 1. Gas means all substances which are gaseous at ambient temperature and ambient pressure. This includes air, oxygen, nitrogen, argon, CO₂ and combustible gases such as propane, butane, natural gas, hydrogen or similar substances. The gases can also be partly in the liquid or in the supercritical state (slush hydrogen, slush). Vehicles are to be understood as land vehicles, water craft and aircraft. The tank of the vehicle can be a transport tank so that, for example, nitrogen can be transported to a customer in a trailer or it can be a feed tank so that the fuel for the vehicle can be stored in this tank such as, for example, natural gas or hydrogen for driving a modern motor or a fuel cell.

Refuelling methods and regulations for compressed hydrogen (currently up to 700 bar) are known from the SAE Standard, SAE TIR J2601 “Surface Vehicle Technical Information Report: Fuelling Protocols for Light Duty Gaseous Hydrogen Surface Vehicle”, published on 16 Mar. 2010.

Known from EP 1 336 795 B1 is a hydrogen filling station having the features of the preamble of claim 1. In this case, pressure and temperature values of the vehicle from the vehicle tank are used to calculated the status of charge—degree of filling, SOC.

The filling station directly takes over these values which are read out from the communication of the vehicle with all the inaccuracies and errors which these values include. These values are then used to determine the SOC's. The filling lasts until the vehicle sensors notify a corresponding SOC value. The refuelling is then ended. The switch-off parameters are defined individually by the respective vehicle manufacturer. However, a corresponding manufacturer's standard such as, for example, SAE TIR J2601, can also be used for this purpose. The switch-off criteria include so-called “Refuelling Commands” (filling status messages such as Car Ready, Abort, etc.).

The disadvantage of this method is that vehicle transmitters are always used to calculate the target pressure or the SOC's. These transmitters have too high a deviation or too low an accuracy for installation construction. They are therefore not suitable for optimally controlling the filling of storage containers from the safety engineering point of view. Since the values are not passed via a fail-safe system, they also cannot be accepted into the controller as fail-safe values. It is therefore difficult to construct a fail-safe system on this basis. Values transmitted from the vehicle to the communication are not absolute values of the sensor system. These are converted or interpreted per vehicle program. Errors lying within the interpretation software of the vehicle are therefore not improved or recognized. Also the sensor system of the vehicles is not located at the same point in all vehicle manufacturers. Therefore the SOC evaluation varies depending on the placing. This results overall in a relatively uncertain filling of the pressure container.

It is the object of the method according to the invention to achieve the filling for vehicles with pressurized gas as safely as possible. Since the filling values lie in very high ranges (700 bar), safety has a very high importance.

This object is solved according to the invention by a filling station having the features of claim 1. Embodiments of the invention and refuelling method are subject matters of the subclaims.

According to the invention, two computers are provided which determine the degree of filling SOC completely independently of one another. This increases the safety. Since the computer on the filling station side exclusively accesses its own measured values, more reliable values can be used for refuelling than in the prior art where pressure and temperature data from the vehicle are used. Since only the SOC of the vehicle is transmitted via the communication line, significantly fewer errors than in the prior art can occur, where current pressure and temperature values must always be transmitted. An advantage of the invention is that the safety of the filling process increases with the accuracy of the sensors.

The installation according to the invention calculates an installation SOC from the installation sensors or transmitters. The vehicle calculates the vehicle SOC from the vehicle sensors. Both systems are used for an abort. In principle, the vehicle should abort (increased installation window). Should the vehicle not abort the refuelling within the installation window, the refuelling will be aborted in any case by the installation. The system is therefore based on two separate computers and two separate sensor systems. This results in a safe refuelling process which is monitored independently by both sides. In contrast to the prior art in which one computer accesses an interpreting sensor system in the automobile via an unsafe connection, where the relatively inexpensive automobile sensors serve as the source, here more accurate measurement data of the higher-quality measuring devices on the filling station side are accessed.

In one embodiment of the invention, a temperature measuring device can be used for the gas temperature in the tank pipe. Under certain circumstances (e.g. fixed pre-cooling temperature) the gas temperature in the tank pipe can also be determined by another method (e.g. fixed value). Likewise, an ambient temperature sensor can be used. With appropriate installation parameters, this can also be replaced by other measurement methods or by a fixed value or temperature tables. In one embodiment of the method according to the invention, only installation pressure and temperature information (gas temperature for the filling, ambient temperature transmitter and pressure transmitter e.g. in the filling line or directly at the tapping point) and without interposed interpretation of a software or a non-fail-safe transmission, are used to calculate the installation SOC's. This value is compared during the filling with the value from the vehicle which leads to an aborting of the refuelling when the permissible SOC value of the vehicle is exceeded. How the SOC value is calculated in the vehicle is left to the vehicle manufacturer. The decisive values are in any way determined by the filling station computer.

The communication line need not continuously transmit data but it is sufficient if this transmits a signal when filling the tank (SOC=100%) from the vehicle to the computer. The communication point can therefore be constructed relatively simply and correspond to the hitherto usual communication devices such as a bus, a WLAN bus, a Profibus F, an infrared connection, a radio connection, an optical cable, a Bluetooth connection or a simple electrical cable.

The installation can be constructed to be fail-safe. There is no difference in the SOC calculation depending on the interpretation/position of the various vehicle sensors. A fail-safe system is compared with a second system, resulting in a higher safety of the entire system. Due to the fail-safe property of the first system, the improved entire system can also be deemed to be fail-safe. Some or all of the sensors can be executed in F-variant. Sensors which are not available in an appropriate safety class can also be made fail-safe by other methods (e.g. duplicated design). Thus, a fail-safe system can be constructed which uses fail-safe computers (programmable logic controller, PLC), fail-safe sensors or fail-safe bus systems. In addition, the filling station according to the invention is compared with a second system or monitored by this. The refuelling command from the SOC calculation in the vehicle gives an abort signal. Thus, the entire system can be regarded as fail-safe. For example, the ambient temperature, the gas temperature and the initial vehicle tank pressure serve as the basis for calculating the filling pressure (and associated with this, the SOC). A tank temperature resulting from the refuelling is calculated with the aid of these values and with the aid of stored substance properties of the gas such as, for example hydrogen (from a material data table such as the NIST table or an SAE table). This temperature yields a desired pressure for the refuelling. At this pressure the required hydrogen filling in the refuelling system is reached, i.e. 100% SOC, or reaching the end pressure which, for example, in modern vehicles is 700 bar. This value is reduced by a percentage X for the refuelling, in a communication refuelling the desired pressure will be increased by precisely this percentage so that 100% SOC is reached. The vehicle also calculates the 100% SOC with the data from the vehicle's own reliable sensors. If the desired SOC of the vehicle should be exceeded during refuelling, the vehicle aborts by means of refuelling command. This double monitoring ensures that the vehicle cannot be overfilled. If problems should arise inside the vehicle, the refuelling can also be aborted by the fail-safe system present on the filling station side.

One embodiment of the invention will be described in detail with reference to a figure.

The figure shows schematically on the left-hand side the important elements of the filling station important for the refuelling and on the right-hand side the elements of the vehicle important for the refuelling. Located between the two at the bottom is the tank pipe or the hose for transferring the gas from the storage tank VT into the vehicle tank and at the top the drawing shows the communication connection KV which is preferably shown as infrared bus. Located in the vehicle tank is a temperature sensor TT and a pressure sensor PT from which a computer in the vehicle calculates the SOC vehicle, that is the filling pressure or the filling ratio determined according to the vehicle. The information “Refuelling Commands” (Ref. Corn.) goes via the communication connection KV to the computer of the filling station (PLC of the filling installation).

In addition to the storage tank VT, the fail-safe measuring devices F-UT for the ambient temperature, F-TT for the temperature of the gas and F-PT for the pressure of the gas (the last two preferably in the filling line) are disposed in the filling station. From these measured values the refuelling is calculated and/or monitored in the computer of the filling station (PLC of the filling installation). Data from the NIST or SAE table which calculate the actual degree of filling (SOC filling station) are used as initial data for the computer. This SOC filling station is characterised by a significantly higher accuracy and reliability compared with the SOC vehicle.

The refuelling takes place as described in SAE TIR J2601 with the connection of the vehicle to the tank pipe and to the communication connection KV. A pressure pulse is then sent via the tank pipe to the vehicle tank which on the one hand is used to test the tightness of the entire installation and on the other hand is used here according to the invention so that the pressure measuring device F-PT determines how much gas is still present in the vehicle tank. The computer, for example, assumes as target pressure 700 bar at 15° C. and takes this as SOC 100% or complete filling of the tank. The expected final temperature 85° C. after refuelling, for example, is determined from the values stored in the filling station computer. From this the computer calculates a target pressure and uses this to control the refuelling. The refuelling continues until this target pressure is reached or until the computer of the vehicle gives a signal via the communication connection KV that its SOC vehicle is 100%.

1. A filling station for a pressurized gas for refuelling a vehicle tank, wherein
a storage tank,
a computer on the filling station side, which can open and close a discharge valve,
a tank pipe between storage tank and vehicle tank to be filled and
a communication connection to the vehicle are provided, characterized in that
a vehicle-side computer for calculating a vehicle-side degree of filling status of charge, and
a pressure measuring device on the filling station side in the tank pipe are provided
wherein the computer on the filling station side calculates the initial status of charge for the filling station from a measured value of the pressure measuring device on the filling station side and at least one temperature value and controls the refuelling with the information of the pressure measuring device on the filling station side until the target pressure or target status of charge for the filling station or until an abort signal which comes from the vehicle-side computer.

2. The filling station according to claim 1, characterised in that a temperature measuring device on the filling station side in the tank pipe, an ambient temperature measuring device and/or an empirical value is used to determine the temperature.

3. The filling station according to claim 1, characterised in that the communication connection is selected from the group consisting of a bus, a WLAN-BUS, a Profi-Bus F, an infrared connection, a Bluetooth connection and an electrical cable.

4. The filling station according to claim 1, characterised in that the temperature measuring device on the filling station side, the pressure measuring device on the filling station side and/or the ambient temperature measuring device are fail-safe.

5. The filling station according to claim 1, characterised in that a material data table is used to calculate the filling station.

6. A method for filling a vehicle tank at a filling station with a pressurized gas, wherein
a storage tank,
a computer on the filling station side, which can open and close a discharge valve,
a tank pipe between storage tank and vehicle tank to be filled and
a communication connection to the vehicle are used, characterised in that
a vehicle-side computer for calculating the vehicle-side degree of filling status of charge and
a pressure measuring device on the filling station side in the tank pipe are used and the computer on the filling station side calculates the initial status of charge for the SOC filling station from a measured value of the pressure measuring device on the filling station side and at least one temperature, and controls the refuelling with the information of the pressure measuring device on the filling station side up to the target pressure or the target status of charge for the filling station or up to the abort signal which comes from the vehicle-side computer.

7. The filling station according to claim 1 wherein said pressurized gas is selected from the group consisting of hydrogen and natural gas.

8. The method according to claim 6 wherein said pressurized gas is selected from the group consisting of hydrogen and natural gas.
